(19) United States
(12) Patent Application Publication
(10) Pub. No.: US 2014/0244322 A1
(43) Pub. Date: Aug. 28, 2014

(54) APPLICATION RECEIVING SYSTEM, CONTROL METHOD FOR APPLICATION RECEIVING SYSTEM, AND PROGRAM

(71) Applicant: Rakuten, Inc., Tokyo (JP)

(72) Inventors: Kenta MATSUI, Tokyo (JP); Misato TAKAHASHI, Tokyo (JP); Moriyoshi KOIZUMI, Tokyo (JP); Shin AOYAMA, Tokyo (JP); Masahiro MATSUI, Tokyo (JP)

(73) Assignee: Rakuten, Inc., Tokyo (JP)

(21) Appl. No.: 14/187,347

(22) Filed: Feb. 24, 2014

(30) Foreign Application Priority Data
Dec. 25, 2012 (JP) 2012-281853

(51) Int. Cl. G06Q 10/02

(52) U.S. Cl. CPC G06Q 10/02
USPC 705/5

(57) ABSTRACT

A reception order setting unit sets an order for receiving an application from a first user. A reception standby unit holds start of reception of the application on standby, based on the order. An estimated reception start time and date information obtaining unit obtains estimated reception start time and date information on an estimated time and date at which reception of the application will be started, based on the order. A presentation unit presents to the first user the estimated reception start time and date information. The estimated reception start time and date information obtaining unit updates the estimated reception start time and date information, based on a reception completion state concerning an application from a second user with an earlier order than the order of the first user. The presentation unit is able to present to the first user the estimated reception start time and date information updated.

### TECHNICAL FIELD

The present invention relates to an application receiving system, a control method for an application receiving system, and a program.

### BACKGROUND ART

There has been known a system for receiving an application for reservation or purchase of a product or a service. Conventionally, in such a system, when an excessively large processing load is resulted due to access from many users, reception of the application is suspended and a message, such as, for example, “we are experiencing heavy traffic. Please try again later”, or the like, may be notified to the users.

In the above described system, the reception of the application is suspended and the above mentioned message is notified to the users also when a large number of users in view of the remaining quantity of the product or service access the system.

Further, in the system described in Patent Literature 1, a connection request from a terminal is rejected and a booking is made when a processing load exceeds a predetermined range, and connection from a booked terminal is accepted once the processing load is decreased to within a predetermined range.

### CITATION LIST

### Patent Literature

Patent Literature 1: JP 2003-058499 A

### SUMMARY OF INVENTION

### Technical Problem

In the above described system, however, a user may feel frustrated as not knowing how long they have to wait before making another access. Moreover, the user may have to repetitively access the system, even though an application is not yet received, as not knowing how long they have to wait before making another access.

The present invention has been conceived in view of the above, and an object thereof is to provide an application receiving system, a control method for an application receiving system, and a program capable of assisting a user to know a time at which reception of an application will be started.

### Solution to Problem

In order to achieve the above described object, an application receiving system according to the present invention includes reception order setting means for setting, in a case of access from a user wanting to apply for reservation or purchase of a product or a service, an order for receiving an application from the user; reception standby means for holding start of reception of the application on standby, based on the order; estimated reception start time and date information obtaining means for obtaining estimated reception start time and date information on an estimated time and date at which the reception of the application is started, based on the order, in a case where the start of the reception of the application is held on standby; presentation means for presenting to the user the estimated reception start time and date information obtained; and reception means for starting the reception of the application, based on the order, wherein the estimated reception start time and date information obtaining means includes means for updating and obtaining the estimated reception start time and date information, based on a reception completion state concerning an application from other user with the order earlier than the order of the user, and the presentation means is able to present to the user the estimated reception start time and date information updated and obtained.

A control method for an application receiving system according to the present invention includes a reception order setting step of setting, in a case of access from a user wanting to apply for reservation or purchase of a product or a service, an order for receiving an application from the user; a reception standby step of holding start of reception of the application on standby, based on the order; an estimated reception start time and date information obtaining step of obtaining estimated reception start time and date information on an estimated time and date at which the reception of the application is started, based on the order, in a case where the start of the reception of the application is held on standby; and a presentation step of presenting to the user the estimated reception start time and date information obtained, wherein the estimated reception start time and date information obtaining step includes a step of updating and obtaining the estimated reception start time and date information, based on a reception completion state concerning an application from other user with the order earlier than the order of the user, and at the presentation step, the estimated reception start time and date information updated and obtained is able to be presented to the user.

A program according to the present invention is a program for causing a computer to function as: reception order setting means for setting, in a case of access from a user wanting to apply for reservation or purchase of a product or a service, an order for receiving an application from the user; reception standby means for holding start of reception of the application on standby, based on the order; estimated reception start time and date information obtaining means for obtaining estimated reception start time and date information on an estimated time and date at which the reception of the application is started, based on the order, in a case where the start of the reception of the application is held on standby; and presentation means for presenting to the user the estimated reception start time and date information obtained, wherein the estimated reception start time and date information obtaining means includes means for updating and obtaining the estimated reception start time and date information, based on a reception completion state concerning an application from other user with the order earlier than the order of the user, and the presentation means is able to present to the user the estimated reception start time and date information updated and obtained.

An information storage medium according to the present invention is a computer readable information storage medium storing the above mentioned program.

According to one embodiment of the present invention, the reception means may receive the application within a predetermined time limit, and the estimated reception start time and date information obtaining means may obtain the estimated reception start time and date information, based on the order and the time limit.

According to one embodiment of the present invention, the reception means may receive in parallel the applications from the number of users equal to or smaller than the upper limit number, and the reception means may include means for changing the upper limit number, based on the contents of the applications from the users.

According to one embodiment of the present invention, the estimated reception start time and date information update means may include means for updating the estimated reception start time and date information, based on a change in the upper limit number.

According to one embodiment of the present invention, the application receiving system may further include means for obtaining, from the user, the content of the application from the user before the reception of the application is started, and the presentation means may include means for presenting information in accordance with the content of the application from the user to the user in a case where the start of the reception of the application is held on standby.

According to one embodiment of the present invention, the presentation means may include means for presenting information on the remaining quantity of the product or service to the user in a case where the start of the reception of the application is held on standby.

According to one embodiment of the present invention, the presentation means may include means for presenting information on the content of an application from other user with the order earlier than the order of the user to the user in a case where the start of the reception of the application is held on standby.

According to one embodiment of the present invention, the presentation means may include means for presenting a waiting time until the estimated time and date at which the reception of the application is started to the user at a predetermined time interval in a case where the start of the reception of the application is held on standby.

According to one embodiment of the present invention, the application receiving system may further include means for notifying, in a case where the waiting time until the estimated time and date at which the reception of the application is started becomes equal to or smaller than a threshold, the user of the fact.

According to one embodiment of the present invention, the application receiving system may further include determination means for determining whether or not the user is able to reserve or buy the product or the service, based on the order and the remaining quantity of the product or service, in a case where the start of the reception of the application is held on standby, and means for notifying the user of a result of determination by the determination means.

### Advantageous Effects of Invention

According to the present invention, it is possible to assist a user to know a time at which reception of an application will be started.

### BRIEF DESCRIPTION OF DRAWINGS

FIG. 1 shows one example of an overall structure of an application receiving system according to an embodiment of the present invention;

FIG. 2 shows one example of a hardware structure of a reception control server and an application reception server;

FIG. 3 shows one example of a ticket selection screen;

FIG. 4 shows one example of an application screen;

FIG. 5 shows one example of a wait screen;

FIG. 6 explains a reception order, a waiting time, and an estimated reception start time and date;

FIG. 7 shows one example of a start screen;

FIG. 8 shows one example of a user table;

FIG. 9 shows one example of an event table;

FIG. 10 shows one example of a ticket table;

FIG. 11 shows one example of a reception status table;

FIG. 12 is a function block diagram of the application receiving system;

FIG. 13 shows one example of processing executed in the application receiving system;

FIG. 14 shows one example of processing executed in the application receiving system;

FIG. 15 shows one example of processing executed in the application receiving system;

FIG. 16 shows one example of processing executed in the application receiving system;

FIG. 17 shows one example of processing executed in the application receiving system;

FIG. 18 shows one example of processing executed in the application receiving system;

FIG. 19 shows one example of processing executed in the application receiving system;

FIG. 20 explains a modified example of the application receiving system.

### DESCRIPTION OF EMBODIMENTS

In the following, an example of an embodiment of the present invention will be described in detail, based on the drawings.

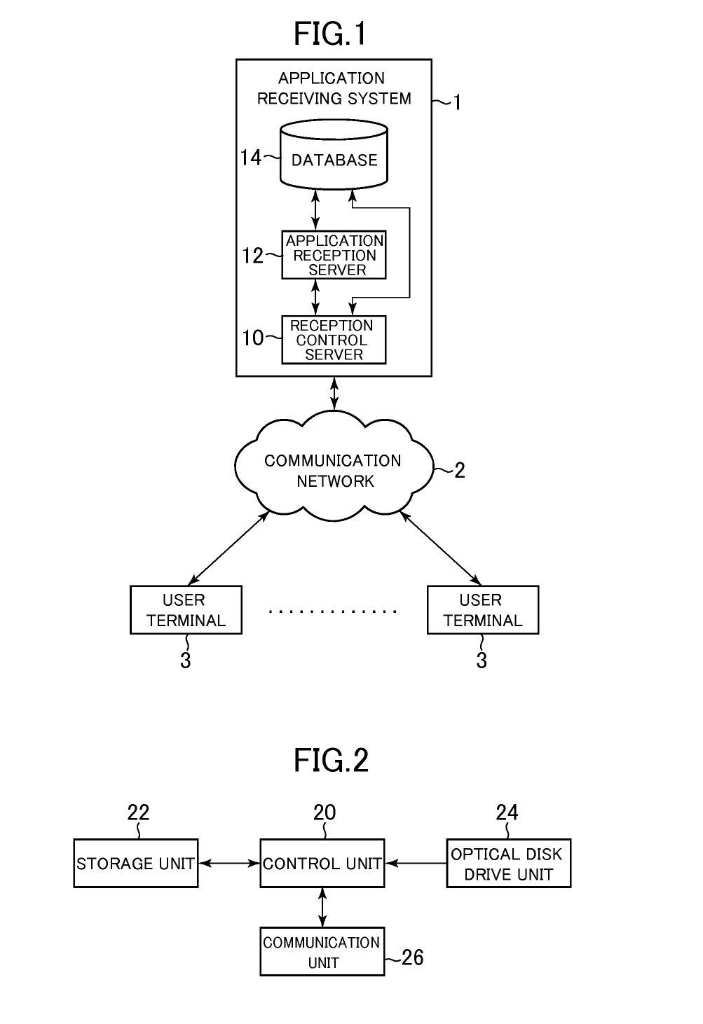

FIG. 1 shows one example of an overall structure of an application receiving system according to an embodiment of the present invention. An application receiving system 1 is a system for receiving an application for reservation or purchase of a product or a service. As shown in FIG. 1, the application receiving system 1 according to this embodiment includes a reception control server 10, an application reception server 12, and a database 14.

The application reception server 12 is a server for receiving an application from a user. The reception control server 10 is a server for controlling reception. The reception control server 10 controls access from a user terminal 3 to the application reception server 12.

FIG. 2 shows one example of a hardware structure of each of the reception control server 10 and the application reception server 12. As shown in FIG. 2, each of the reception control server 10 and the application reception server 12 includes a control unit 20, a storage unit 22, an optical disk drive unit 24, and a communication unit 26.

The control unit 20 includes, for example, one or more microprocessors, and execute processing according to an operation system or a program stored in the storage unit 22. The storage unit 22 includes a main memory unit and an auxiliary storage unit. For example, the main memory unit is a RAM, and the auxiliary storage unit is a hard disk, a solid state drive, or the like.

The optical disk drive unit 24 reads a program and data recorded on an optical disk (an information storage medium). The program and data are supplied to the storage unit 22 via the optical disk. That is, the program and data recorded on the optical disk are read by the optical disk drive unit 24, and stored in the storage unit 22.

Each of the reception control server 10 and the application reception server 12 may include a structural element for reading a program or data stored in an information storage medium other than an optical disk (for example, a memory card). Then, the program and data may be supplied to the storage unit 22 via the information storage medium other than an optical disk.

The communication unit 26 is used for data communication via a communication network 2. A program and data may be supplied to the storage unit 22 via the communication network 2.

Data communication is possible between the reception control server 10 and the application reception server 12. The reception control server 10 and the application reception server 12 may be implemented by a single server computer.

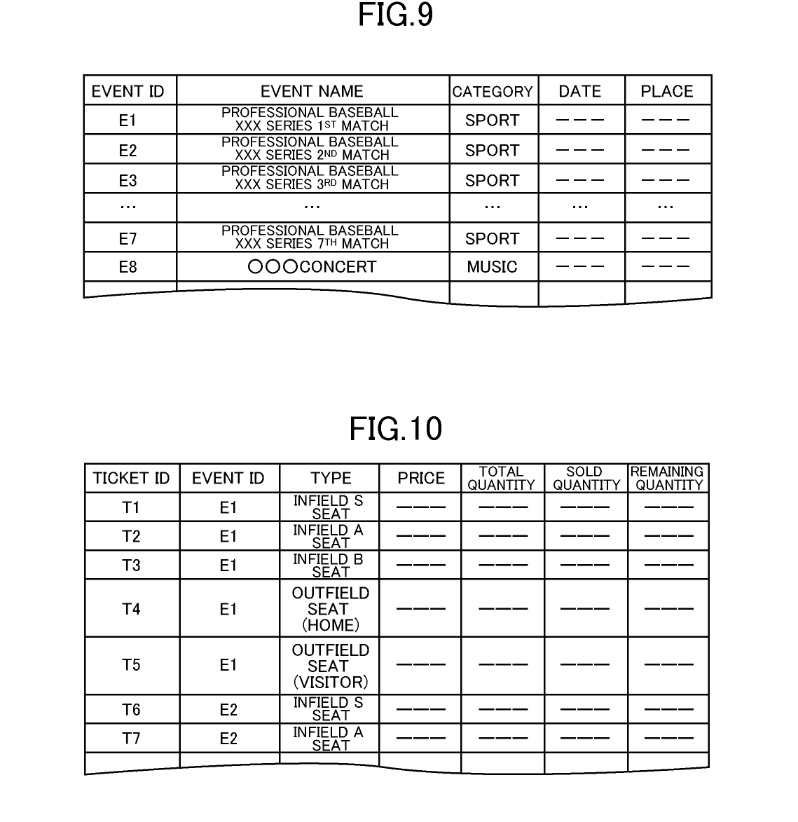

The reception control server 10 and the application reception server 12 can access the database 14. The database 14 may be created in a server computer different from the reception control server 10 and the application reception server 12 or in either of the reception control server 10 and the application reception server 12. For example, data necessary to receive an application for reservation or purchase of a product or a service is stored in the database 14. Data stored in the database 14 will be described later (see FIGS. 9 to 12).

The user terminal 3 is an information processing device for use by a user to apply for reservation or purchase of a product or a service. The user terminal 3 is, for example, a portable phone, a portable information terminal, a personal computer, or the like. Data communication is possible via the communication network 2 between the reception control server 10 and the user terminal 3. Data communication is also possible via the communication network 2 between the application reception server 12 and the user terminal 3.

For example, an HTTP daemon is activated in each of the reception control server 10 and the application reception server 12. Further, a session can be shared by the reception control server 10 and the application reception server 12. Meanwhile, a browser is activated in the user terminal 3. A processing request (HTTP request) is sent from the user terminal 3 to the reception control server 10 or the application reception server 12 via the browser. A processing result (HTTP response) in response to the above mentioned processing request is sent from the reception control server 10 or the application reception server 12 to the user terminal 3. For example, page data written in a web page descriptive language is sent to the user terminal 3, and a screen based on the processing result is displayed on a display unit in the user terminal 3, based on the page data.

Note that although the description below is based on an assumption that communication between the user terminal 3 and the reception control server 10 or the application reception server is executed according to HTTP, a communication format for communication between the user terminal 3 and the reception control server 10 or the application reception server 12 may be any communication format other than the communication format according to HTTP.

In the above described application receiving system 1, an application for reservation or purchase of a product or a service is received. In particular, when a user has to wait for start of reception of an application, an estimated reception start time and date (or a waiting time) is presented to the user in the application receiving system 1. Further, a time limit during which a user completes an application procedure (an application time limit: for example, 10 minutes) is set in the application receiving system 1 to improve accuracy in estimation of the reception start time and date or the waiting time. In the following, the above describe function will be described.

Initially, a procedure to be followed by a user in applying for reservation or purchase of a product or a service will be described. In the following, the above mentioned procedure will be described, referring to a case as an example in which an application for purchase of a ticket of various events, such as a sport match, a concert, or the like, is received. That is, the above described procedure will be described, referring to a case as an example in which the product is a “ticket”.

Initially, a user accesses the application receiving system 1 from their terminal 3 to select a desired event. Upon selection of a desired event by the user, a ticket selection screen for selection of a ticket is displayed on the display unit of the user terminal 3.

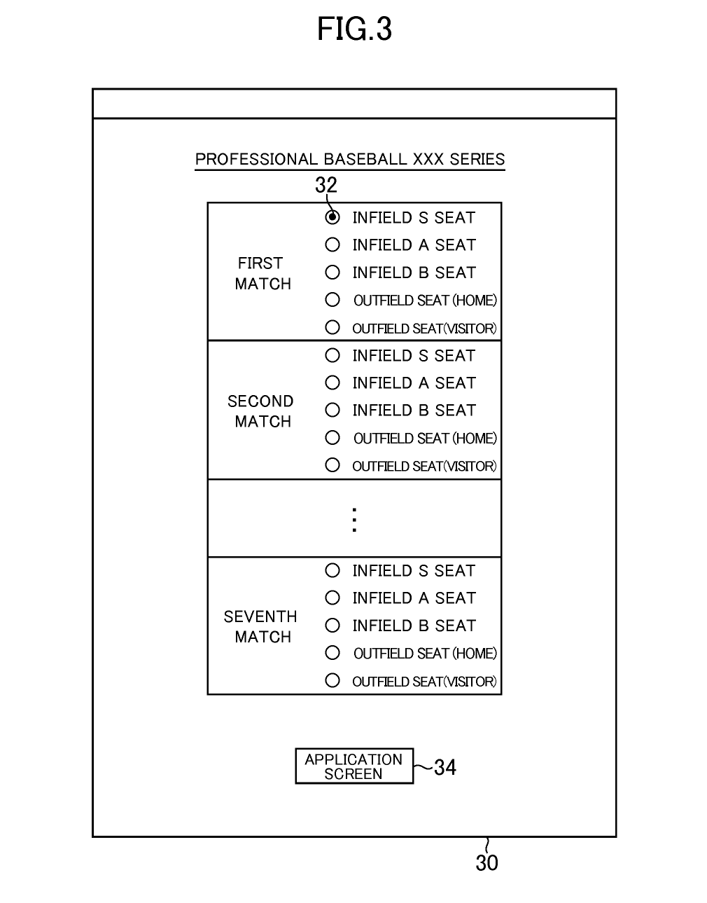

FIG. 3 shows one example of the ticket selection screen. FIG. 3 shows a ticket selection screen 30 to be displayed when a professional baseball game is selected as the desired event. In this event, a match between two professional baseball teams is played, and a team that first wins four matches is the winner. In this event, seven matches are played at the maximum supposing no game is drawn.

In the ticket selection screen 30, a user selects any option button 32 to thereby select a desired match among the seven matches and a seat type. For brevity of the description, the description below is based on an assumption that one match and one seat type can be selected, though it may be arranged for selection of a plurality of matches or seat types.

After selection of any option button 32, the user presses an application screen button 34. With the application screen button 34 pressed, it is determined whether or not the application for purchase of the ticket is immediately received, based on the number of users who want the ticket same as the thicket selected in the ticket selection screen 30 among users accessing the application receiving system 1.

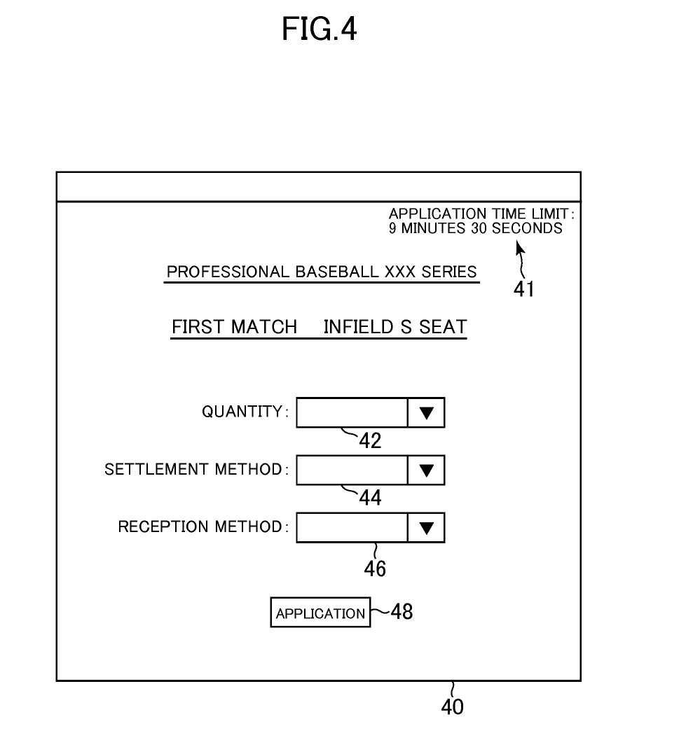

A case in which it is determined that the application for purchase of the ticket is immediately received will be described. In this case, an application screen for applying for purchase of the ticket is displayed. FIG. 4 shows one example of the application screen, which includes an application time limit space 41, a quantity space 42, a settlement method space 44, a reception method space 46, and an application button 48.

In the application receiving system 1, a time limit (for example, ten minutes) during which a user completes an application procedure is set, and the remaining time until the application time limit elapses is shown in the application time limit space 41. The time shown in the application time limit space 41 is updated at a predetermined time interval. For example, the time interval is set to one second, and the time shown in the application time limit space 41 is decreased by every one second, for example, as time passes. In this case, the application time limit space 41 corresponds to a countdown timer. The time interval may be desirably set by an administrator of the application receiving system 1.

A user designates a quantity for a desired ticket in the quantity space 42. Further, a user designates a settlement method and a reception method in the settlement method space 44 and the reception method space 46, respectively. A seat chart of an event hall may be shown in the application screen 40. A user may be allowed to designate one or more seats in the seat chart to thereby designate one or more desired seats.

With the application button 48 pressed, ticket purchase processing is executed. For example, settlement processing and ticket issuing processing are executed. The ticket issuing processing may be processing for issuing an electronic ticket to the user or processing for issuing a paper ticket to the user. After execution of the ticket purchase processing, for example, a screen (not shown) for informing the user of completion of the ticket purchase processing is displayed on the display unit of the user terminal 3.

The above mentioned “application time limit” refers to a limit period of time until the application button 48 in the application screen 40 is pressed. That is, the user needs to press the application button 48 before the application time limit elapses. If the user fails to press the application button 48 before elapse of the application time limit, the application procedure is stopped, which is notified to the user.

A case in which it is determined that the application for purchase of the ticket is not immediately received will be described below. In this case, a wait screen for waiting for start of reception of the application is displayed on the display unit of the user terminal 3.

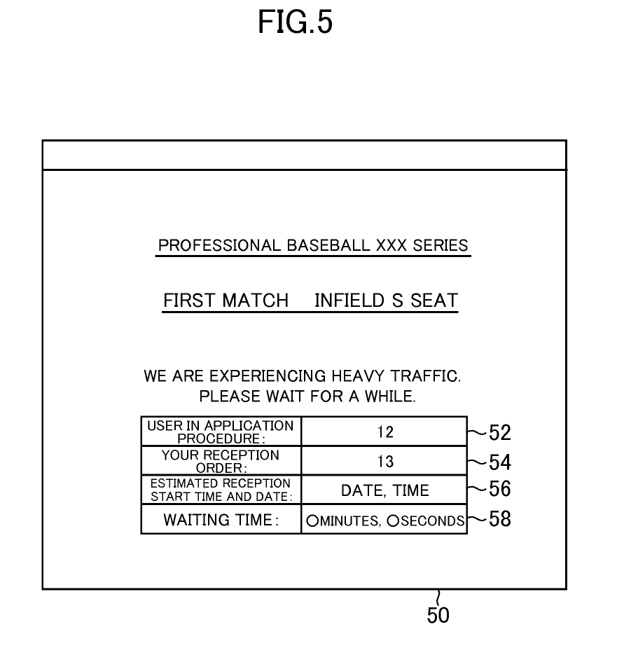

FIG. 5 shows one example of the wait screen. As shown in FIG. 5, the wait screen 50 includes a reception status space 52, a reception order space 54, an estimated reception start time and date space 56, and a waiting time space 58.

In the application receiving system. 1, an order for receiving applications from a plurality of users wanting the same tickets is determined. In the reception status space 52, the order of a user whose application is currently received is shown. In the reception order space 54, the reception order allocated to the concerned user is shown. In the estimated reception start time and date space 56, an estimated time and date at which reception of an application from the concerned user will be started is shown. In the waiting time space 58, a waiting time left before reception of an application from the concerned user will be started is shown. The waiting time shown in the waiting time space 58 is updated at a predetermined time interval. For example, the time interval is set to one second, and the waiting time shown in the waiting time space 58 is decreased by every one second as time passes. In this case, the waiting time space 58 corresponds to a countdown timer. The time interval may be desirably set by the administrator of the application receiving system 1.

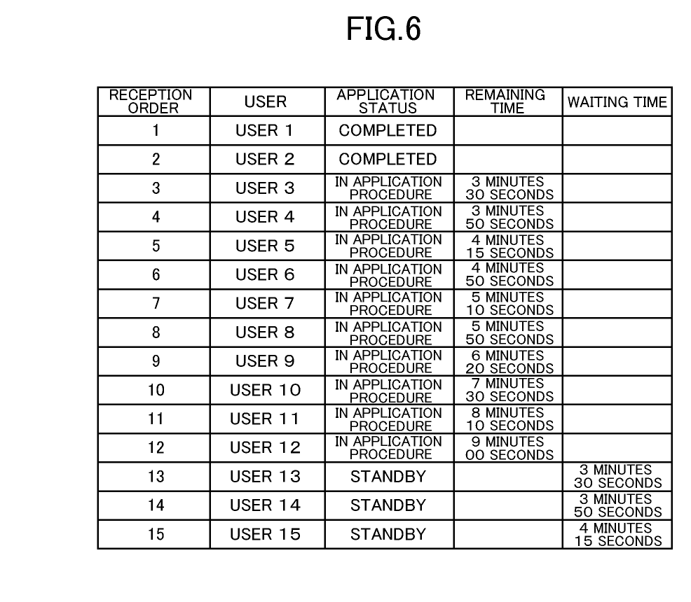

Below, the reception order, the estimated reception start time and date, and the waiting time will be described in more detail. FIG. 6 explains the reception order, the estimated reception start time and date, and the waiting time, and is related to a case in which fifteen users want the same ticket.

As shown in FIG. 6, in this case, reception orders from “1” to “15” are allocated to fifteen respective users. Specifically, an earlier reception order is allocated to a user showing an intention of buying a ticket earlier. That is, the reception order of a user having shown an intention of buying a ticket at the i^{th} order (i: an integer being one or larger) is set to “the i^{th} order”. Note that when the application screen button 34 in the ticket selection screen 30 is pressed, it is considered that an intention of buying a ticket is shown.

Reception of the application is started, beginning with a user with an earlier reception order. In the application receiving system 1, however, applications from the number of users wanting the same tickets, the number being equal to or smaller than the upper limit number are received at the same time in parallel.

For example, in a case where the remaining quantity of the ticket is “50” and the upper limit quantity of a ticket which one user can buy is “5”, if ten users each buy five tickets, zero ticket is left. If such applications for purchase of the thicket are received from eleven or more users at the same time, it is possible that a user who cannot buy a desired quantity of tickets is resulted.

In order to avoid such inconvenience, the upper limit number is set to “10” in such a case in the application receiving system 1.

In the situation shown in FIG. 6, users with the reception order “1” and “2” have already finished the application procedure, users with the reception order “3” to “12” are engaging in the application procedure, and users with the reception order “13” to “15” are on standby. A “remaining time” in FIG. 6 refers to a remaining period of time until the application time limit elapses.

In the situation shown in FIG. 6, the remaining time of the user with the reception order “3” among the users engaged in the application procedure is “three minutes and thirty seconds”, which is the shortest. In such a case, reception of an application from a user with the earliest reception order among the users on standby, namely, the user with the reception order “13”, will be started after waiting of three minutes and thirty seconds at the maximum. Therefore, the waiting time of the user with the reception order “13” is “three minutes and thirty seconds”. In this case, a point of time at which the waiting time (three minutes and thirty seconds) will have just elapsed since the current point of time makes the estimated reception start time and date of the user with the reception order “13”.

Similarly, the remaining time of the user with the reception order “4” among the users engaged in the application procedure is “three minutes and fifty seconds”, which is the second shortest. In such a case, reception of an application from a user with the second earliest reception order among the users on standby, namely, the user with the reception order “14”, will be started after waiting of three minutes and fifty seconds at the maximum. Therefore, the waiting time of the user with the reception order “14” is “three minutes and fifty seconds. In this case, a point of time at which the waiting time (three minutes and fifty seconds) will have just elapsed since the current point of time makes the estimated reception start time and date of the user with the reception order “14”.

As described above, the waiting time of a user with the i^{th} earliest reception order among the users on standby corresponds to the remaining time of a user with the i^{th} earliest reception order among the users engaged in the application procedure. Further, the estimated reception start time and date of a user with the i^{th} earliest reception order among the users on standby corresponds to a point of time at which the above described waiting time will have just elapsed since the current point of time, that is, a point of time at which the application time limit of the user with the i^{th} earliest reception order among the users engaged in the application procedure will have just elapsed.

When any of the users engaged in the application procedure completes the application procedure, reception of an application from a user with the earliest reception order among the users on standby is started. In the situation shown in FIG. 6, for example, when the application procedure of the user with the reception order “5” is completed, reception of an application from a user with the earliest reception order among the users on standby, namely, the user with the reception order “13”, is started.

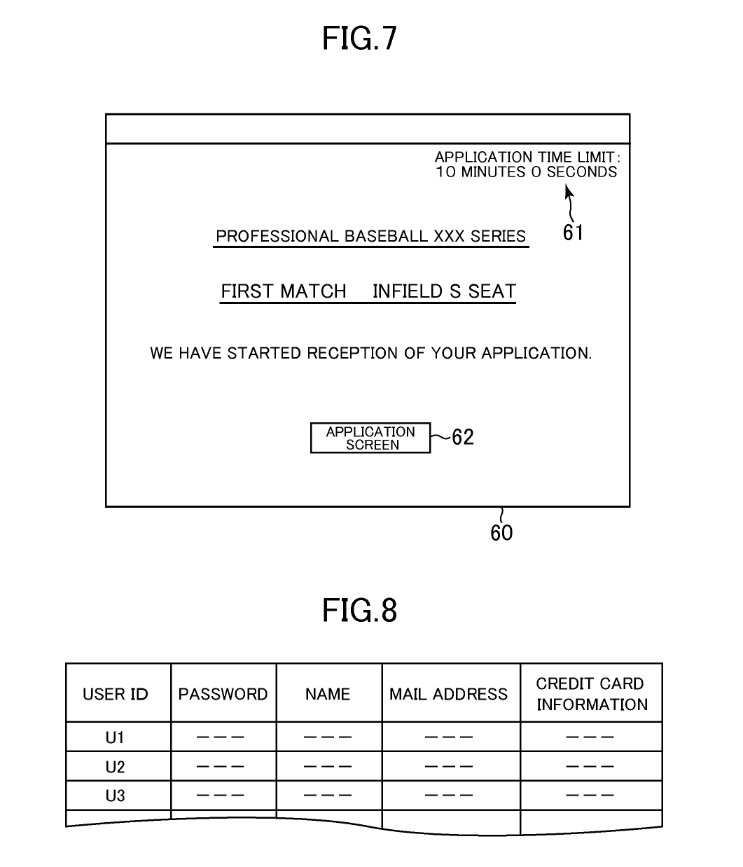

In this case, a start screen for notifying of start of reception of the application is displayed on the display unit of the user terminal 3. FIG. 7 shows one example of the start screen. As shown in FIG. 7, the start screen 60 includes an application time limit space 61 and an application screen button 62. Similar to the application time limit space 41 in the application screen 40, the remaining time until the application time limit elapses is shown in the application time limit space 61. The time shown in the application time limit space 61 is decreased by every one second, for example, as time passes. When the application screen button 62 is pressed, the application screen 40 is displayed on the display unit of the user terminal 3.

When reception of an application from the user with the reception order “13” is started, the user with the reception order “14” now becomes a user with the earliest reception order among the users on standby. Therefore, the waiting time of the user with the reception order “14” is shortened to “three minutes and thirty seconds”. Similarly, the user with the reception order “15” now becomes a user with the second earliest reception order among the users on standby. Therefore, the waiting time of the user with the reception order “15” is shortened to “three minutes and fifty seconds”.

In the above described application receiving system 1, even when a large number of users in view of the remaining quantity of the ticket access, it is possible to execute reception of an application without suspension.

Further, in the application receiving system 1, a user can know how long they have to wait until start of reception of an application, by referring to the information shown in the wait screen 50.

Further, in the application receiving system 1, as the application time limit (for example, ten minutes) until completion of the application procedure is set, it is possible to improve accuracy of the estimated reception start time and date and the waiting time. That is, it is ensured that a situation in which reception is not started even when it becomes the estimated reception start time and date is avoided.

Further, in the application receiving system 1, the information shown in the wait screen 50 is updated, based on the reception completion state of other users with an earlier reception order than that of the user. For example, when another user completes the application procedure in a shorter period of time than the application time limit, the estimated reception start time and date and the waiting time to be presented to the user is shortened.

In the following, a structure for implementing the above described application receiving system 1 will be described. Initially, one example of data stored in the database 14 will be described. FIGS. 8 to 11 show one example of data stored in the database 14.

FIG. 8 shows one example of a user table. A user table indicates a list of users using the application receiving system 1. For example, the user table includes “user ID”, “password”, “name”, “mail address”, and “credit card information” fields.

The “user ID” field indicates information (user ID) for uniquely identifying a user. The “password” field indicates a password designated by the user. The “name” and “mail address” fields indicate the name and mail address of the user. The “credit card information” field indicates information on a credit card of the user.

FIG. 9 shows one example of an event table. An event table indicates a list of events of which tickets are sold in the application receiving system 1. For example, the event table includes “event ID”, “event name”, “category”, “date”, and “place” fields.

The “event ID” field indicates information (event ID) for uniquely identifying an event. The “event name” field indicates the name of the event. The “category” field indicates a category of the event. The “date” and “place” fields indicate a time and date when the event takes place, and a place where the event takes place, respectively.

FIG. 10 shows one example of a ticket table. A ticket table indicates information relevant to a ticket of each event. The ticket table includes “ticket ID”, “event ID”, “type”, “price”, “total quantity”, “sold quantity”, and “remaining quantity” fields.

The “ticket ID” field indicates identification information (ticket ID) for uniquely identifying the kind of a ticket. Note that tickets with the same ticket ID will be hereinafter referred to as the same tickets. The “event ID” field is similar to the “event ID” field in the event table. The “type” field indicates the type of a seat. The “price” field indicates a selling price.

The “total quantity” field indicates the total quantity of the tickets. The “sold quantity” field indicates the quantity of the tickets sold. The “remaining quantity” field indicates the remaining quantity of the ticket (the quantity of tickets available for sale). As the number in the “remaining quantity” field can be obtained from the numbers in the “total quantity” and “sold quantity” fields, either one of the “sold quantity” and the “remaining quantity” may be omissible.

For a reservation seat ticket, a table for managing which seat is bought by which user is stored in the database 14 in addition to the ticket table, which, however, is omitted here. In addition, a table indicating ticket purchase history as well is stored in the database 14, which, however, is omitted here.

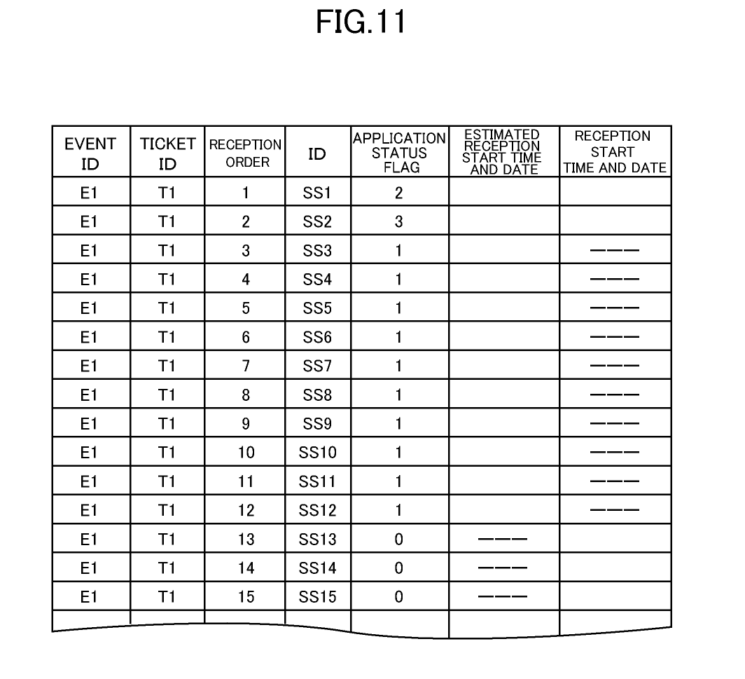

FIG. 11 shows one example of a reception status table. A reception status table is a table indicating a reception status concerning a ticket purchase application. For example, the reception status table includes “event ID”, “ticket ID”, “reception order”, “ID”, “application status flag”, “estimated reception start time and date”, and “reception start time and date” fields.

The “event ID” and “ticket ID” fields indicate an event ID and a ticket ID of a ticket which a user intends to buy. As a ticket which a user intends to buy can be identified based only on the ticket ID, the “event ID” field may be omissible.

The “reception order” field indicates a reception order allocated to the user. The “ID” field indicates identification information for uniquely identifying the user. For example, a session ID is registered in the “ID” field.

The “application status flag” field indicates a reception status concerning an application from the user. For example, “0”, “1”, “2”, or “3” is registered in the “application status flag” field. The value “0” indicates that reception of the application is not yet started. That is, the value “0” indicates that the user is on standby. The value “1” indicates that reception of the application is already started. That is, the value “1” indicates that the user is engaged in the application procedure. The value “2” indicates that the application procedure is duly completed. The value “3” indicates that reception of the application is stopped as the application time limit elapses before completion of the application procedure.

The “estimated reception start time and date” field indicates a time and date at which reception of an application from the user is estimated to be started. The “reception start time and date” field indicates a time and date at which reception of an application from the user is actually started.

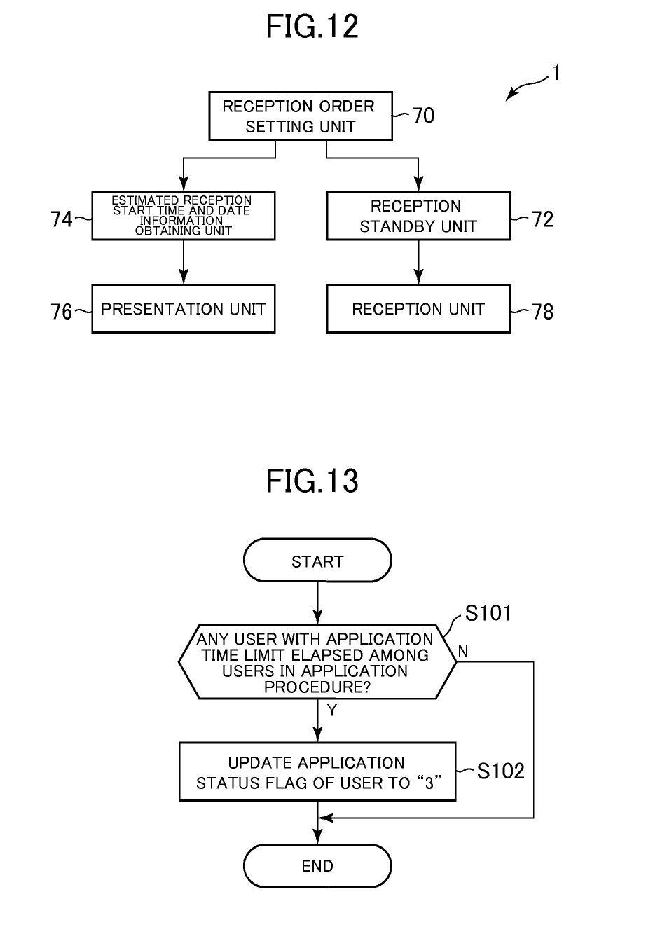

In the following, function blocks implemented in the application receiving system 1 will be described. FIG. 12 is a function block diagram showing function blocks relevant to the present invention among the function blocks implemented in the application receiving system 1.

As shown in FIG. 12, the application receiving system 1 includes a reception order setting unit 70 (reception order setting means), a reception standby unit 72 (reception standby means), an estimated reception start time and date information obtaining unit 74 (estimated reception start time and date information obtaining means), a presentation unit 76 (presentation means), and a reception unit 78 (reception means). The respective function blocks shown in FIG. 12 are implemented by the reception control server 10 or the application reception server 12. That is, the control unit 20 of the reception control server 10 and the control unit 20 of the application reception server 12 execute processing according to a program, whereby the respective function blocks shown in FIG. 12 are implemented.

The reception order setting unit 70 will be described. Upon access from a user wanting to reserve or buy a product or a service, the reception order setting unit 70 sets a reception order for the user. The “reception order” is an order at which to receive an application for reservation or purchase from the user.

For example, the reception order setting unit 70 sets the reception order such that reception of an application is started, beginning with a user showing an intention of reserving or buying earlier. Alternatively, the reception order setting unit 70 may set the reception order such that reception of an application is started, beginning with a user having accessed earlier a specific screen (for example, the ticket selection screen 30) in the application receiving system 1.

Further, the reception order setting unit 70 sets the reception order for every product or service. For example, the reception order setting unit 70 sets the reception order for every ticket.

For example, in a case where a user X shows an intention of buying a thicket A at the i^{th} order among users wanting the ticket A, the reception order setting unit 70 sets a reception order for the user X to the “i^{th} order”. For example, when the application screen button 34 is pressed with the ticket A selected in the ticket selection screen 30, the reception order setting unit 70 considers that an intention of buying the thicket A is shown.

The reception standby unit 72 will be described. The reception standby unit 72 holds start of reception of an application from a user on standby, based on the reception order of the user. That is, the reception standby unit 72 restricts (suspends) start of reception of an application from a user, based on the reception order of the user.

For example, upon access from the user X who wants the thicket A, if the number of users engaged in the application procedure for the thicket A is equal to the upper limit number, the reception standby unit 72 holds start of reception of an application from the user X on standby.

Meanwhile, when the number of users engaged in the application procedure for the thicket A becomes smaller than the upper limit number, the reception standby unit 72 holds start of reception of an application from the user X on standby, based on the reception order of the user X.

Assume here that the reception order of a user is the i^{th} earliest among the users on standby for an application for the thicket A. Further assume that the number of users engaged in the application procedure is N, and the upper limit number is Nmax. When i, Nmax, and N hold the relationship i>Nmax−N, the reception standby unit 72 holds start of reception of an application from the user X on standby.

The upper limit number is determined based on the remaining quantity of the ticket, as described above. For example, in a case where the remaining quantity of the ticket A is “50”, and the upper limit quantity of the thicket A which one user can buy is “5”, if an application for purchase of the thicket A is received from eleven or more users at the same time, it is possibly that a user who cannot buy a desired quantity of tickets A is resulted. In order to avoid such inconvenience, the upper limit number is set to “10” in such a case.

The estimated reception start time and date information obtaining unit 74 will be described. The estimated reception start time and date information obtaining unit 74 obtains estimated reception start time and date information of a user. The “estimated reception start time and date information” refers to information on an estimated time and date at which reception of an application from a user will be started. For example, the “estimated reception start time and date information” may be information indicating an estimated reception start time and date or information indicating a waiting time until the estimated reception start time and date. Further, the estimated reception start time and date information may be obtained at a point of time at which it is determined that reception of the application is held on standby or at or after a point of time at which reception of the application is held on standby.

The estimated reception start time and date information obtaining unit 74 obtains estimated reception start time and date information of a user, based on the reception order of the user and the application time limit. For example, the estimated reception start time and date information obtaining unit 74 estimates a reception start time and date of the user, based on the reception order of the user and the application time limit, to thereby obtain the estimated reception start time and date information of the user.

For example, assuming that the reception order of the user X is the i^{th} earliest among the users on standby for an application for the ticket A, the estimated reception start time and date information obtaining unit 74 estimates a point of time at which the application time limit of a user with the i^{th} earliest reception order (i: integer being one or larger) among the users engaged in the application procedure for the thicket A will have just elapsed, as the estimated reception start time and date of the user X.

The presentation unit 76 will be described. The presentation unit 76 presents the reception start time and date information of a user to the user. For example, the presentation unit 76 presents at least one of the reception start time and date and the waiting time of a user to the user. The reception start time and date information may be presented at a point of time at which it is determined that reception of the application is held on standby or at or after a point of time at which reception of the application is held on standby.

For example, the presentation unit 76 displays the estimated reception start time and date and the waiting time of a user in the estimated reception start time and date space 56 and the waiting time space 58, respectively, in the wait screen 50. The presentation unit 76 may display a progress bar image (a gauge image) or a sand clock image indicating the remaining time (the waiting time) until the estimated reception start time and date of the user, instead of displaying the estimated reception start time and date space 56 and the waiting time space 58.

Alternatively, the presentation unit 76 may display a combination of the number of other users on standby with earlier reception orders than that of the user and the application time limit. For example, in a case where three users with earlier reception orders than that of the user is on standby, the presentation unit 76 may show a message, such as “you are the third to be accepted” or “three people ahead of you before receiving your application”, together with the application time limit. In this case, an average or standard application time per each person may be displayed, instead of displaying the application time limit. An “application time” refers to a period of time to be taken to complete the application procedure.

The reception unit 78 will be described. The reception unit 78 starts reception of an application from a user, based on the reception order of the user, to receive the application from the user within a predetermined application time limit.

Further, the reception unit 78 simultaneously receives applications for the same tickets from a plurality of users in parallel. That is, the reception unit 78 simultaneously receives applications for the same tickets from the number of users equal to or smaller than the upper limit number in parallel.

For example, when the number of users engaged in the application procedure for the thicket A is smaller than the upper limit number, the reception unit 78 selects one or more users from among the users on standby for an application for the ticket A, based on the reception orders of the respective users, such that the number of users engaged in the application procedure for the thicket A becomes equal to the upper limit number. That is, the reception unit 78 selects one or more users sequentially from among the users on standby for an application for the ticket A, beginning with a user with an earlier reception order, and then receives an application for purchase of the ticket A from the selected user.

In the following, processing that is executed in the application receiving system 1 will described. FIG. 13 shows one example of processing that is executed in the reception control server 10 for every predetermined period of time (for example, one minute). The processing shown in FIG. 13 is to update the reception status table.

As shown in FIG. 13, the control unit 20 of the reception control server 10 accesses the reception status table to determine whether or not there is a user whose application time limit has elapsed among the users engaged in the application procedure (S101).

Note that the “user engaged in the application procedure” refers to a user with the application status flag “1”. Whether or not the application time limit has elapsed can be determined by determining whether or not the application time limit (for example, ten minutes) has elapsed since the reception start time and date.

When it is determined that there is a user whose application time limit has elapsed, the control unit 20 stops reception of an application from that user. That is, the control unit 20 accesses the reception status table, and updates the application status flag of the user to “3” (S102).

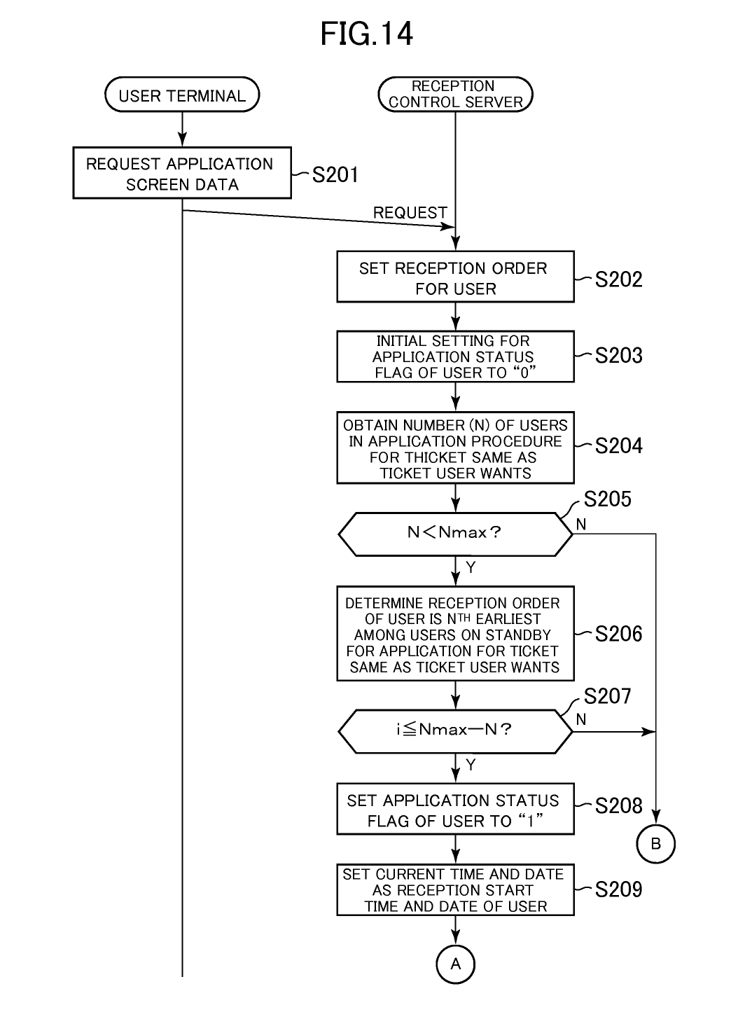

FIGS. 14 to 16 show one example of processing that is executed when the application screen button 34 in the ticket selection screen 30 is pressed. The control units 20 of the reception control server 10 and of the application reception server 12 respectively execute the processing shown in FIGS. 14 to 16 according to a program, whereby the function blocks shown in FIG. 12 are implemented.

When the application screen button 34 in the ticket selection screen 30 is pressed, as shown in FIG. 14, the control unit of the user terminal 3 requests the reception control server 10 for screen data on the application screen 40 (S201). In this case, the event ID and the ticket ID of a ticket wanted by a user are sent to the reception control server 10. In the processing described below as well, the event ID and the ticket ID of the ticket wanted by the user are sent upon access to the reception control server 10 or the application reception server 12 from the user terminal 3.

When the request is received by the reception control server 10, the control unit 20 (the reception order setting unit 70) of the reception control server 10 sets a reception order for the user (S202). Further, the control unit 20 makes initial setting for the application status flag of the user by setting to “0” (S203).

At steps S202 and S203, the control unit 20 adds a new record to the reception status table, and then registers the information below in the respective fields of the newly added record.

That is, the control unit 20 registers the event ID and the ticket ID of the ticket wanted by the user in the “event ID” and “ticket ID” fields, respectively. Further, the control unit 20 obtains the reception order of a user with the last reception order among the users wanting the ticket same as the ticket wanted by the user, and registers the reception order subsequent by one to that reception order in the “reception order” field. Further, the control unit 20 registers a session ID in the “ID” field, and the value “0” in the “application status flag” field.

Thereafter, with reference to the reception status table, the control unit 20 obtains the number (N) of users engaged in the application procedure for the ticket same as the ticket wanted by the user (S204). That is, the control unit 20 obtains as the number (N) the number of records with the event ID and ticket ID of the ticket wanted by the user registered in the “event ID” field and the “ticket ID” field thereof, respectively, and with the value “1” registered in the “application status flag” field.

Then, the control unit 20 determines whether or not the number (N) is smaller than a threshold (Nmax) (S205). As described above, in the application receiving system 1, applications for the same tickets are simultaneously received in parallel from the number of users equal to or smaller than the upper limit number, in which the upper limit number is set as the threshold (Nmax).

For example, in a case where the remaining quantity of the ticket A is “50” and the upper limit quantity of the thicket A which one user can buy is “5”, “10” is set as the threshold (Nmax) for the ticket A. As the remaining quantity of the ticket is different for every ticket, the threshold (Nmax) is set for every thicket. Further, the upper limit quantity of a ticket which one user can buy may be different for every ticket.

When it is determined that the number (N) is smaller than the threshold (Nmax), the control unit 20 determines the reception order of the user set at step S202 is the n^{th} earliest among those of the users on standby for an application for the ticket same as the ticket wanted by the user (S206). A “user engaged in the application procedure” refers to a user with the application status flag “0”. The following processing will be described based on an assumption that it is determined at step S206 that the reception order of the user is the i^{th} earliest among the users on standby for an application for the ticket same as the ticket wanted by the user.

Thereafter, the control unit 20 determines whether or not the relationship i≦Nmax−N is held (S207). When it is determined that the relationship i≦Nmax−N is held, the control unit 20 (the reception unit 78) executes processing for starting reception of an application from the user.

That is, the control unit 20 sets the application status flag of the user to “1” (S208), and registers the current time and date as the reception start time and date of the user (S209). That is, the control unit 20 accesses the reception status table, registers the value “1” in the “application status flag” field of a record with the session ID registered in the “ID” field, and registers the current time and date in the “reception start time and date” field.

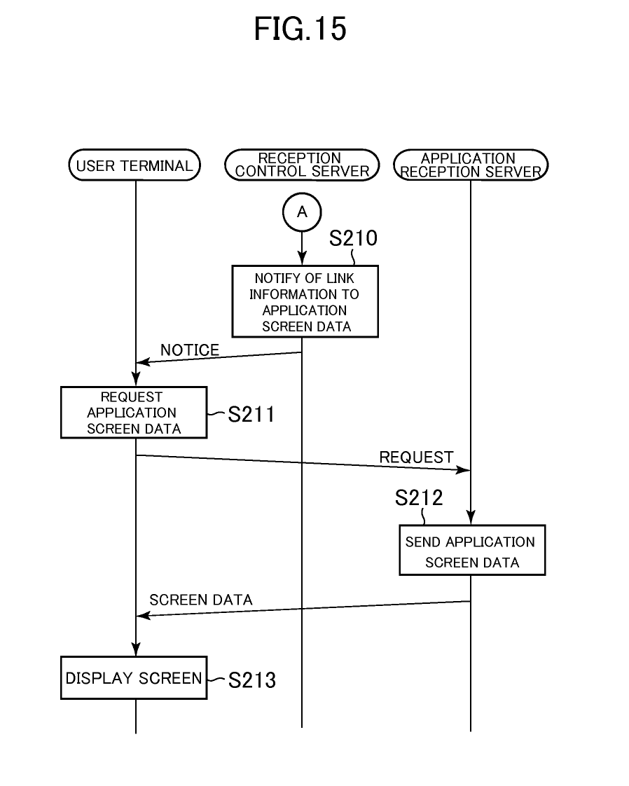

Thereafter, as shown in FIG. 15, the control unit 20 notifies the user terminal 3 of link information to the screen data on the application screen 40 (S210). Then, the control unit of the user terminal 3 requests the application reception server 12 for the screen data on the application screen 40, according to the link information (S211). When the request is received by the application reception server 12, the control unit 20 of the application reception server 12 sends the screen data on the application screen 40 to the user terminal 3 (S212).

Note that information for displaying the remaining time until the application time limit elapses in the application time limit space 41 is embedded in the screen data (page data) on the application screen 40. For example, a combination of the reception start time and date and the application time limit is embedded as the above mentioned information. Alternatively, a time and date at which the application time limit will have elapsed is embedded as the above mentioned information. Still alternatively, the remaining period of time after the current point of time until a point of time at which the application time limit will have elapsed is embedded as the above mentioned information.

Further, a program for updating the time displayed in the application time limit space 41 for every predetermined period of time (for example, one second) is embedded in the screen data (page data) on the application screen 40. While the application screen 40 is displayed on the display unit of the user terminal 3, the program is executed whereby the time displayed in the application time limit space 41 is updated for every predetermined period of time (for example, one second).

When the screen data on the application screen 40 is received in the user terminal 3, the control unit of the user terminal 3 displays the application screen 40 on the display unit (S213).

When it is determined at step S205 in FIG. 14 that the number (N) is equal to or larger than the threshold (Nmax) or when it is determined at step S207 that the relationship i≦Nmax−N is not held, the control unit 20 (the reception standby unit 72) executes processing for holding reception of an application from the user on standby.

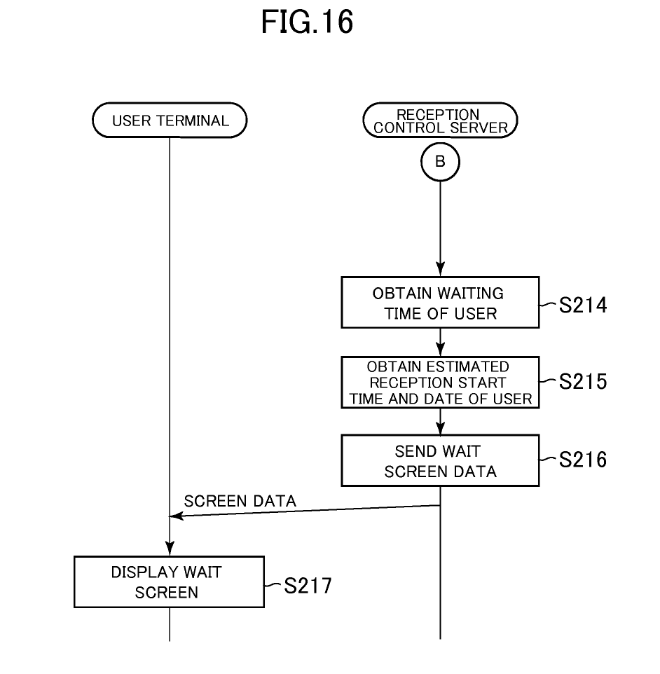

That is, as shown in FIG. 16, the control unit 20 (the estimated reception start time and date information obtaining unit 74) obtains the waiting time of the user (S214). For example, when the reception order of the user is the i^{th} earliest among the users on standby for an application for the ticket same as the ticket wanted by the user, the control unit 20 accesses the reception status table, and obtains the remaining time of the user with the i^{th} earliest reception order among the users engaged in the application procedure for the ticket same as the ticket wanted by the user, as the waiting time of the user. Note that the “remaining time” refers to a remaining period of time until the application time limit elapses.

The control unit 20 (the estimated reception start time and date information obtaining unit 74) obtains the estimated reception start time and date of the user (S215). For example, the control unit 20 obtains a time and date at which the waiting time obtained at step S214 will have elapsed since the current time and date, as the estimated reception start time and date. In this case, the control unit 20 accesses the reception status table, and registers the obtained estimated reception start time and date in the “estimated reception start time and date” field of a record with the session ID registered in the “ID” field.

Thereafter, the control unit 20 (the presentation unit 76) sends the screen data on the wait screen 50 to the user terminal 3 (S216). In this case, the reception order of the user is set in the reception order space 54 in the wait screen 50. Further, the estimated reception start time and date obtained at step S215 is set in the estimated reception start time and date space 56, and the waiting time obtained at step S214 is set in the waiting time space 58. Still further, the reception order of a user with the last reception order among the users engaged in the application procedure for the ticket same as the ticket wanted by the user is registered in the reception status space 52.

When the screen data on the wait screen 50 is received by the user terminal 3, the control unit of the user terminal 3 displays the wait screen 50 on the display unit (S217).

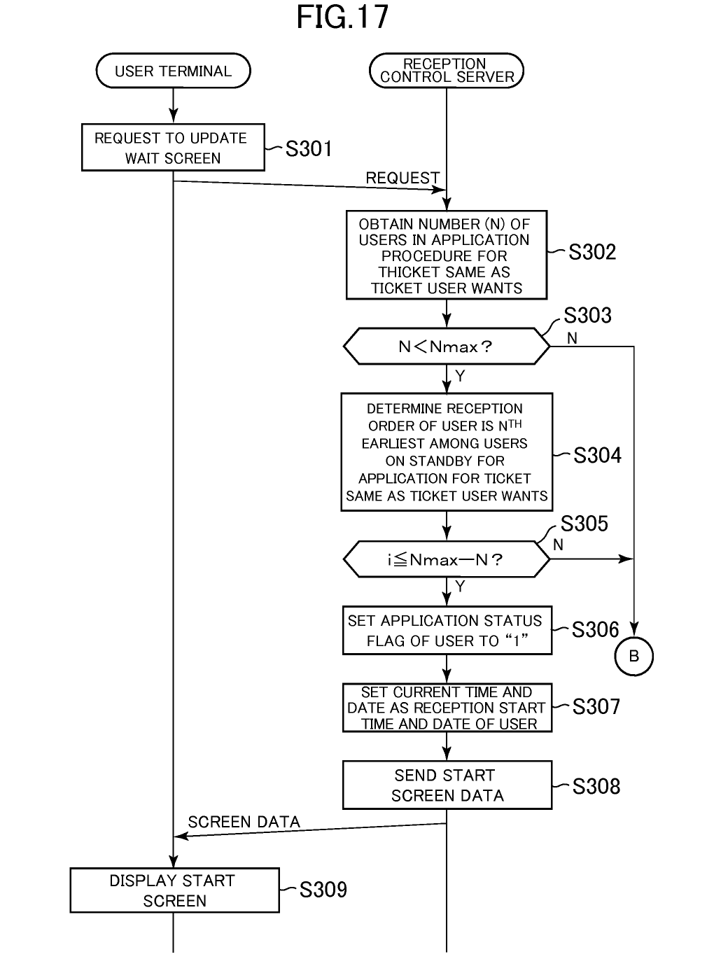

FIG. 17 shows one example of processing that is executed when the wait screen 50 is displayed. In the screen data (page data) on the wait screen 50, a program for requesting the reception control server 10 to update the wait screen 50 for every predetermined period of time (for example, one minute) is embedded. Therefore, while the wait screen 50 is displayed, the control unit of the user terminal 3 requests the reception control server 10 to update the wait screen 50 for every predetermined period of time (S301).

When the request is received in the reception control server 10, the control unit 20 of the reception control server 10 obtains the number (N) of users engaged in the application procedure for the ticket same as the ticket wanted by the user, with reference to the reception status table (S302). Then, the control unit 20 determines whether or not the number (N) is equal to or larger than a threshold (Nmax) (S303). These steps S302, S303 are similar to steps S204, S205 in FIG. 14.

When it is determined that the number (N) is smaller than the threshold (Nmax), the control unit 20 determines that the reception order of the user is the n^{th} earliest among the users on standby for an application for the ticket same as the ticket wanted by the user (S304). Then, the control unit 20 determines whether or not the relationship i≦Nmax−N is held (S305). These steps S304, S305 are similar to steps S206, S207 in FIG. 14.

Meanwhile, when it is determined at step S303 that the number (N) is equal to or larger than the threshold (Nmax) or when it is determined at step S305 that the relationship i≦Nmax−N is not held, the control unit 20 (the reception standby unit 72) executes the processing (S214 to S216) shown in FIG. 16, and as a result, the wait screen 50 displayed on the display unit of the user terminal 3 is updated (S217). In this case, the waiting time and the estimated reception start time and date of the user are updated based on the application reception completion state of other users with earlier reception orders than that of the user, and the updated waiting time and the updated estimated reception start time and date are presented to the user.

In the situation shown in FIG. 6, for example, when the user with the reception order “4” completes the application procedure before the user with the reception order “3”, reception of an application from the user with the reception order “13” is started. In this case, the user with the reception order “14” becomes a user with the earliest reception order among the users on standby, and as a result, the waiting time of the user with the reception order “14” is shortened to “three minutes and thirty seconds”.

When it is determined at step S305 that the relationship i≦Nmax−N is held, the control unit 20 (the reception unit 78) updates the application status flag of the user to “1” (S306), and sets the current time and date as the reception start time and date of the user (S307). These steps S306, S307 are similar to steps S208, S209 in FIG. 14.

Thereafter, the control unit 20 sends to the user terminal 3 the screen data on the start screen 60 for notifying of start of reception of an application (S308).

Similar to the screen data on the application screen 40, information for displaying the remaining time until the application time limit elapses in the application time limit space 61 and a program for updating the time displayed in the application time limit space 61 for every predetermined period of time (for example, one second) are embedded in the screen data (page data) on the start screen 60 as well.

When the screen data on the start screen 60 is received in the user terminal 3, the control unit of the user terminal 3 displays the start screen 60 on the display unit (S309).

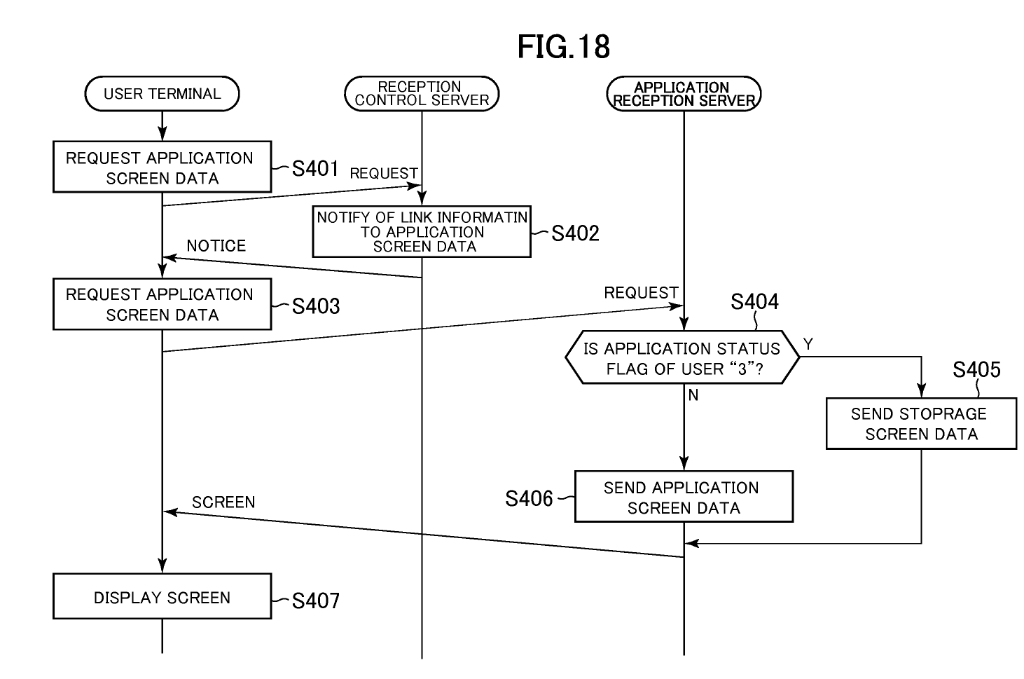

While the start screen 60 is displayed, the control unit of the user terminal 3 monitors whether or not the application screen button 62 is pressed. FIG. 18 shows one example of processing that is executed when the application screen button 62 is pressed.

When the application screen button 62 is pressed, the control unit of the user terminal 3 requests the reception control server 10 for the screen data on the application screen 40, as shown in FIG. 18 (S401). In this case, the control unit 20 of the reception control server 10 notifies the user terminal 3 of link information to the screen data on the application screen 40 (S402). Then, the control unit of the user terminal 3 requests the application reception server 12 for the screen data on the application screen 40, according to the link information (S403).

When the request is received in the application reception server 12, the control unit 20 of the application reception server 12 determines whether or not the application status flag of the user is set at “3” (S404).

A case in which the application status flag of the user is set at “3” refers to a case in which the application status flag is updated to “3” through the processing shown in FIG. 13 because the application time limit has elapsed before the application screen button 62 in the start screen 60 is pressed. In such a case, the control unit 20 sends to the user terminal 3 the screen data on a stoppage screen for notifying of stoppage of application receiving (S405). In this case, the control unit of the user terminal 3 displays the stoppage screen on the display unit (S407).

Meanwhile, when it is determined that the application status flag of the user is not set at “3”, the control unit 20 sends to the user terminal 3 the screen data on the application screen 40 (S406). In this case, the control unit of the user terminal 3 displays the application screen 40 on the display unit (S407). These steps S406, S407 are similar to steps S212, S213 in FIG. 15.

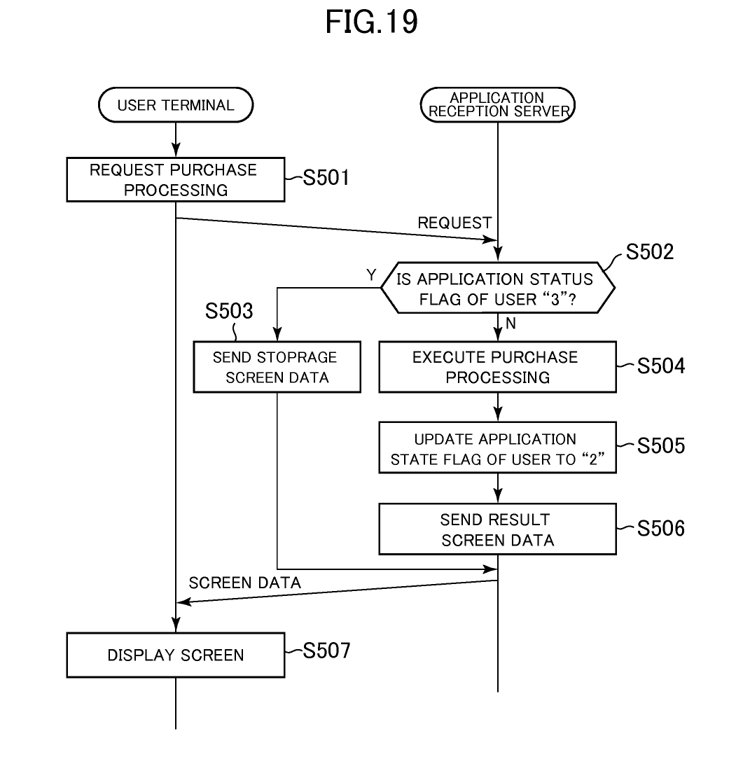

While the application screen 40 is displayed on the display unit of the user terminal 3, the control unit of the user terminal 3 monitors whether or not the application button 48 is pressed. FIG. 19 shows one example of processing that is executed when the application button 48 is pressed.

When the application button 48 is pressed, the control unit of the user terminal 3 requests the application reception server 12 for ticket purchase processing, as shown in FIG. 19 (S501).

When the request is received in the application reception server 12, the control unit 20 of the application reception server 12 determines whether or not the application status flag of the user is set at “3” (S502).

A case in which the application status flag of the user is set at “3” refers to a case in which the application status flag is updated to “3” through the processing shown in FIG. 13 because the application time limit has elapsed before the application button 48 in the application screen 40 is pressed. In such a case, the control unit 20 sends to the user terminal 3 the screen data on the stoppage screen for notifying of stoppage of reception of the application (S503). In this case, the control unit of the user terminal 3 displays the stoppage screen on the display unit (S507).

Meanwhile, when it is determined that the application status flag of the user is not set at “3”, the control unit 20 executes the ticket purchase processing (S504). For example, the control unit 20 executes ticket issuing processing and settlement processing. Further, the control unit 20 accesses the ticket table, and updates the sold quantity and the remaining quantity of the ticket.

Thereafter, the control unit 20 updates the application status flag of the user to “2” (S505). That is, the control unit 20 accesses the reception status table, and updates the value in the “application status flag” field of a record with the session ID registered in the “ID” field from “1” to “2”.

Further, the control unit 20 sends to the user terminal 3 the screen data on a result screen showing a result of the ticket purchase processing (S506). In this case, the control unit of the user terminal 3 displays the result screen on the display unit (S507).

In the above described application receiving system 1, even when a large number of users in view of the remaining quantity of the product or service access, it is possible to execute reception of an application without suspension.

In the application receiving system 1, a user can know how long they have to wait until reception of an application will be started, by referring to the information displayed in the wait screen 50. That is, according to the application receiving system 1, an advantage for a user can be obtained that the user can know how long they have to wait until start of reception of an application. Moreover, an advantage for an application receiver can be obtained that a situation in which a user feels frustrated as not knowing how long they have to wait until start of reception of an application can be avoided, which can resultantly improve user satisfaction.

In the application receiving system 1, as the application time limit (for example, ten minutes) during which a user completes the application procedure is set, it is possible to improve accuracy of the estimated reception start time and date and the waiting time. According to the application receiving system 1, it is ensured that a situation in which reception is not started even when the estimated reception start time and date has come is avoided.

In the application receiving system 1, the information displayed in the wait screen 50 is updated based on the reception completion state concerning an application from other user with an earlier reception order than that of the user. For example, when another user completes the application procedure in a period of time shorter than the application time limit, the estimated reception start time and date and the waiting time to be presented to the user is updated.

Note that the present invention is not limited to the above described embodiments.

[1] For example, the presentation unit 76 may present information on the remaining quantity of the product or service to a user in a case where reception of the application from the user is held on standby. For example, the presentation unit 76 may show the remaining quantity of ticket same as the ticket wanted by the user in the wait screen 50. With the above, the user can know the remaining quantity of the ticket same as the ticket the user want while waiting for start of reception.

[2] For example, the presentation unit 76 may present to the user information on the content of application from other user with earlier reception orders than that of the user in a case where reception of the application from the user is held on standby. For example, the presentation unit 76 may display in the wait screen 50 the total quantity of tickets bought by the other users with earlier reception orders than that of the user, out of the tickets same as the ticket wanted by the user. With the above, the user can know the selling state of the desired ticket while waiting for start of reception.

[3] For example, in a case where reception of the application from the user is held on standby, the presentation unit 76 may present information in accordance with the content of the application from the user to the user. For example, the presentation unit 76 may present information on a ticket in the same category as that of the ticket wanted by the user to the user. With the above, the user can effectively make use of the time while waiting for start of reception.

[4] For example, the reception control server 10 may notify the user of a fact, when occurs, that the waiting time of the user becomes equal to or smaller than a threshold.

For example, when the waiting time of the user becomes equal to or smaller than the threshold, the reception control server 10 may send an electric mail or the like to report that fact to the user. In this case, it may be arranged such that the user can input their mail address in the wait screen 50 so that the above mentioned electronic mail is sent to the mail address inputted by the user.

Further, for example, the reception control server 10 may embed a program for displaying a message to the effect that the waiting time of the user becomes equal to or smaller than a threshold, when occurs, in the screen data on the wait screen 50.

[5] For example, in a case where reception of the application from the user is held on standby, the reception control server 10 (the determination means) may determine whether or not the user can reserve or buy the product or service, based on the reception order of the user and the remaining quantity of the product or service. Further, the reception control server 10 may notify the user of a result of determination.

[5-1] For example, in a case where reception of the application from the user is held on standby, the reception control server 10 (the determination means) may determine whether or not the user can reserve or buy the product or service based on the reception order of the user, the remaining quantity of the product or service, and the upper limit quantity of the product or service which one user can apply for.

For example, in the situation shown in FIG. 6, assume a case in which the reception order of the user is “15”. Also, assume a case in which the upper limit quantity of the ticket which one user can buy is five.

In this case, ten users are engaged in the application procedure, and reception orders of two users among the users on wait are earlier than “15”. That is, twelve users can buy the tickets before the user, which means that sixty tickets at the maximum can be bought before the user.

In this case, as the remaining quantity of the ticket is larger than the maximum quantity, the user can buy the ticket. Therefore, the reception control server 10 may notify the user that the user can buy the ticket.

Meanwhile, when the remaining quantity of the ticket is equal to or smaller than the maximum quantity, there is a possibility that the user cannot buy the ticket, and therefore, the reception control server 10 may notify the user that there is a possibility that the user cannot buy the ticket. In this case, as the difference between the remaining quantity of the ticket and the above mentioned maximum quantity is larger, higher possibility is resulted that the user cannot buy the ticket. Thus, an index indicating the level of possibility that the user cannot buy the ticket may be presented to the user, based on the difference between the remaining quantity of the ticket and the above mentioned maximum quantity.

[5-2] For example, in a case where reception of the application from the user is held on standby, the reception control server 10 (the determination means) may determine whether or not the user can reserve or buy the product or the service, based on the reception order of the user, the remaining quantity of the product or service, and the lower limit quantity of the product or service which one user can apply for.

For example, in the situation shown in FIG. 6, assume a case in which the reception order of the user is “15”. Also, assume a case in which the lower limit quantity of the ticket which one user can buy is one.

In this case, ten users are engaged in the application procedure, and the reception orders of two users among the users on wait are earlier the “15”. That is, twelve users can buy the tickets before the user, which means that twelve thickets at the minimum can be bought before the user.

In this case, when the remaining quantity of the ticket is equal to or smaller than the minimum number, the user cannot buy the ticket. Therefore, the reception control server 10 may notify the user that the user cannot buy the ticket.

Meanwhile, when the remaining quantity of the ticket is larger than the minimum number, there is a possibility that the user can buy the ticket. Therefore, the reception control server 10 may notify the user that there is a possibility that the user can buy the ticket. In this case, as the difference between the remaining quantity of the ticket and the above mentioned minimum quantity is larger, higher possibility is resulted that the user can buy the ticket. Thus, an index indicating the level of possibility that the user can buy the ticket may be presented to the user, based on the difference between the remaining quantity of the ticket and the above mentioned minimum quantity.

[6] For example, the reception control server 10 may obtain the quantity wanted by the user (the quantity of products or services) before reception of the application from the user is started. That is, the reception control server 10 may obtain the quantity of tickets wanted by the user from the user. For example, it may be arranged such that the user can designate a desired quantity as well in the ticket selection screen 30. Alternatively, it may be arranged such that the user can designate a desired quantity in the wait screen 50.

[6-1] For example, when the difference between the remaining quantity of the ticket same as the ticket wanted by the user and the quantity wanted by the user is equal to or smaller than a predetermined threshold, the presentation unit 76 may notify the user of that fact. With the above, the user can know, while waiting for start of reception, that the remaining quantity of the ticket same as the ticket wanted by the user is becoming closer to the quantity wanted by the user.

[6-2] For example, the presentation unit 76 may execute notification to the user, based on the remaining quantity of the ticket same as the ticket wanted by the user, the quantity wanted by the user, and adjacent seat availability. That is, the presentation unit 76 may determine whether or not the quantity of adjacent seats wanted by the user are available (that is, the user s desired quantity of adjacent seats in a row), and notify the user of a result of determination.

Generally, a user wanting a plurality of tickets wants a plurality of adjacent seats in a row. In this regard, the above described arrangement allows the user to know whether or not the desired quantity of adjacent seats in a row are available, while waiting for start of reception.

[6-3] For example, the reception unit 78 may change the upper limit number of users from whom applications for the same tickets can be simultaneously received in parallel, based on the users desired quantities designated before reception of an application is started.

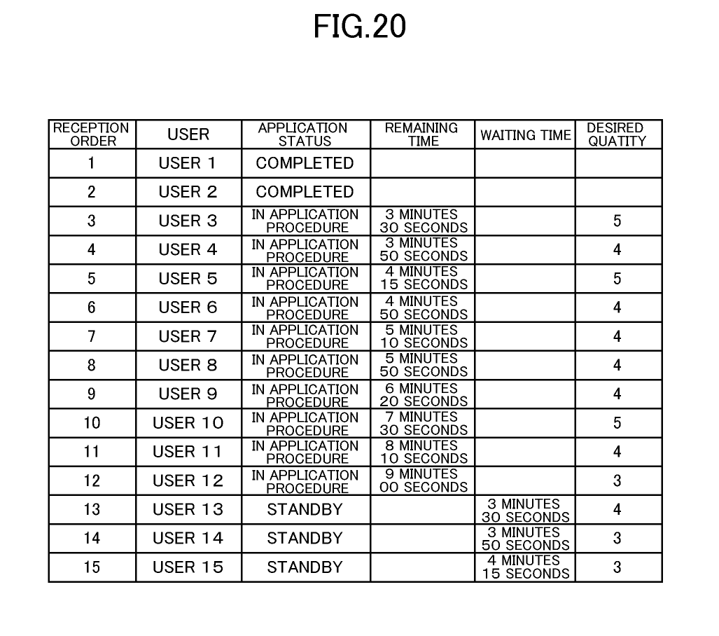

Below, assume a situation shown in FIG. 20. That is, assume that fifty thickets remain. In FIG. 20, a “desired quantity” refers to a desired quantity designated by each user in the ticket selection screen 30 (or in the wait screen 50).

In this case, the total of the desired quantities designated in advance by the ten users engaged in the application procedure is forty two. Further, the desired quantity designated in advance by the user with the earliest reception order among the three users on standby is four. Still further, the desired quantity designated in advance by the user with the second earliest reception order is three. The total of the desired quantities of these thickets is forty-nine, which is fewer than the remaining quantity of the ticket (50).

In this case, the reception unit 78 may increase the upper limit number from 10 to 12 so that applications from the users with the reception orders “13” and “14” as well can be received. That is, the reception unit 78 may increase the upper limit number such that the total of the desired quantities becomes equal to or smaller than the remaining quantity of the ticket.

Further, in this case, the estimated reception start time and date information obtaining unit 74 may update the estimated reception start time and date information, based on the change in the upper limit number.

For example, in the above described case, when reception of applications from the users with the reception orders “13” and “14” is started, the user with the reception order “15” now becomes a user with the earliest reception order among the users on standby. Therefore, the estimated reception start time and date information obtaining unit 74 may change the waiting time of the user with the reception order “15” from “four minutes and fifteen seconds” to “three minutes and thirty seconds”.

[6-4] Further, for example, the reception unit 78 may change the upper limit number of users from whom applications for buying the same tickets can be received simultaneously in parallel, based on the users desired quantities designated before reception of an application is started and the adjacent seat availability.

For example, the reception unit 78 may set the upper limit number of users such that the number of users who can buy a desired quantity of tickets is maximized.

Below, assume a case in which thirteen adjacent seats (that is, thirteen adjacent seats in a row) are available, five users each want one ticket, and six users each want two tickets. A seat is automatically allocated to each user by the application receiving system 1.

In this case, one user wanting one ticket and six users each wanting two tickets can buy the tickets (case A). Alternatively, three users each wanting one ticket and five users each wanting two tickets can buy the tickets (case B). Still alternatively, four users each wanting two tickets and five users each wanting one ticket can buy the tickets (case C).

In the case A, seven users can buy the tickets. In the case B, eight users can buy the tickets. In the case C, nine users can buy the tickets.

In this case, the reception unit 78 may set the upper limit number of users such that the number of users who can buy a desired quantity of tickets is maximized. That is, in the above described example, the reception unit 78 may set the upper limit number of users to “9” so that the number of users who can buy a desired quantity of tickets can be maximized.

In the above described case, the reception order setting unit 70 sets the reception order of the user such that the number of users who can buy a desired quantity of tickets is maximized. That is, in the above described example, the reception order setting unit 70 sets the reception orders of the four users each wanting two tickets and the five users each wanting one ticket earlier than the reception orders of the other users.

In an arrangement that allows a user to designate a seat, there may be a case in which users each wanting one ticket designate seats in a manner that leaves one seat not designated between designated seats, and as a result, a user wanting two tickets cannot buy two adjacent seats. To address the above, in the above described example, the reception order setting unit 70 may set the reception orders of the four users each wanting two seats earlier than those of the five users each wanting one seat. Then, reception of applications from the five users each wanting one ticket may be started after completion of the application procedure by the four users each wanting two tickets. Meanwhile, in an arrangement that automatically allocates a seat to each user by the application receiving system 1, the above described consideration for reception order setting is unnecessary to be made.

With the above, it is possible to have as many users as possible who can buy a desired quantity of tickets.

[7] For example, the presentation unit 76 may display a seat chart of an event hall in the wait screen 50. The presentation unit 76 may reflect the current sold state of the ticket (seat) in the seat chart. For example, the presentation unit 76 may display a seat sold and a seat available distinctively from each other. As the above described modified example 6, in a case in which a user s desired quantity for the tickets is obtained in advance, the user s desired quantity of adjacent seats may be displayed distinctively in the seat chart. With the above, the user can make use of the time while waiting for start of reception.

[8] For example, the user may designate a settlement method and a reception method in the wait screen 50. With the above, the user can make use of the time while waiting for start of reception.

[9] For example, in the above described embodiment, the estimated reception start time and date information or the like is obtained utilizing the upper limit quantity (a fixed number: for example, five) of a ticket which one user can buy. However, the quantity of tickets which each user may possibly buy may be estimated based on the purchase history of the user. For example, a statistical value (for example, the maximum or average) of the quantity of tickets having bought by the user in the past may be obtained as an estimated quantity, and the obtained estimated quantity may be used instead of the upper limit quantity.

[10] For example, in the above described embodiment, the estimated reception start time and date information or the like is obtained utilizing the application time limit (fixed value: for example, ten minutes). However, a period of time needed to complete the application procedure may be estimated for every user, based on the purchase history of the user. For example, a statistical value (for example, the maximum or average) of a period of time needed by the user to complete the application procedure in the past may be obtained as an estimated period of time, and the obtained estimated period of time may be used instead of the application time limit. In this case, it is necessary to keep stored the history on the periods of time needed by each user to complete the application procedure in the past in the database 14.

[11] For example, in the above described embodiment, the user terminal 3 requests the reception control server 10 to update the wait screen 50 for every predetermined period of time (for example, one minute) while the wait screen 50 is displayed. However, the reception control server 10 may determine whether or not update of the wait screen 50 is necessary, and push-send the screen data on the wait screen 50 to the user terminal 3 when update of the wait screen 50 is necessary.

[12] In the above described embodiment, the threshold (Nmax) at step S205 in FIG. 14 is set in view of avoiding a situation in which a user who cannot buy a desired quantity of tickets is resulted. However, the threshold (Nmax) may be set in view of preventing a processing load of the application receiving system 1 from becoming excessively large.

[13] For example, the reception order setting unit 70 may preferentially allocate an earlier order to a user who satisfies a predetermined attribute condition. Alternatively, the reception order setting unit 70 may allocate a later order to a user who satisfies a predetermined attribute condition.

The “attribute condition” refers to a condition concerning attribute information on a user (for example, residential area, gender, job, past number of times of application, priority flag, black list flag, or the like). Note that the “priority flag” is information indicating whether or not the user is to be treated with priority, and the “black list flag” is information indicating whether or not the user is to be alerted or paid attention to.

For example, the attribute condition is set by an administrator of the application receiving system 1. For example, the attribute condition is set in consideration of the content of the product or service.

For example, when an attribute condition “the past number of times of application is equal to or larger than a threshold” is set, the reception order setting unit 70 sets the reception order of a user with the past number of times of application being equal to or larger than the threshold earlier than that of a user with the past number of times of application being smaller than the threshold.

For example, an attribute condition “the residential area is in the area where the event takes place” is set, the reception order setting unit 70 sets the reception order of a user who lives in the area where the event takes place earlier than that of a user who does not live in the area where the event takes place.

For example, when an attribute condition “the black list flag is set on” is set, the reception order setting unit 70 sets the reception order of a user with the black list flag set on later than that of a user with the black list flag not set on.

According to the above described reception order setting unit 70, it is possible to receive with priority or less likely an application from a specific user. In order to implement the above described reception order setting unit 70, it is necessary to keep stored attribute information (for example, residential area, gender, job, past number of times of application, priority flag, black list flag, and the like) necessary to determine whether or not a user satisfies an attribute condition in the database 14.

[14] Although a case of receiving an application to buy a ticket is mainly described in the above, the present invention can be applied to a case of receiving an application to buy a product other than a ticket. Further, the present invention can be applied to a case of receiving an application to reserve a product. Still further, the present invention can be applied to a case of receiving an application to buy or reserve a service.

### DESCRIPTION OF REFERENCE NUMERAL

1 application receiving system, 2 communication network, 3 user terminal, 10 reception control server, 12 application reception server, 14 database, 20 control unit, 22 storage unit, 24 optical disk drive unit, 26 communication unit, 30 ticket selection screen, 32 option button, 34 application screen button, 40 application screen, 42 quantity space, 44 settlement method space, 46 reception method space, 48 application button, 50 wait screen, 52 reception status space, 54 reception order space, 56 estimated reception start time and date space, 58 waiting time space, 60 start screen, 61 application time limit space, 62 application screen button, 70 reception order setting unit, 72 reception standby unit, 74 estimated reception start time and date information obtaining unit, 76 presentation unit, 78 reception unit.

The invention claimed is:

1. An application receiving system, comprising:
a reception order setting unit that sets, in a case of access from a first user wanting to apply for reservation or purchase of a product or a service, an order for receiving an application from the first user;
a reception standby unit that holds start of reception of the application on standby, based on the order;
an estimated reception start time and date information obtaining unit that obtains estimated reception start time and date information on an estimated time and date at which the reception of the application is started, based on the order, in a case where the start of the reception of the application is held on standby;
a presentation unit that presents to the first user the estimated reception start time and date information obtained; and
a reception unit that starts the reception of the application, based on the order, wherein
the estimated reception start time and date information obtaining unit includes a unit that updates and obtains the estimated reception start time and date information, based on a reception completion state concerning an application from a second user with an order earlier than the order of the first user, and
the presentation unit is able to present to the first user the estimated reception start time and date information updated and obtained.

2. The application receiving system according to claim 1, wherein
the reception unit receives the application within a predetermined time limit, and
the estimated reception start time and date information obtaining unit obtains the estimated reception start time and date information, based on the order and the time limit.

3. The application receiving system according to claim 1, wherein
the reception unit receives in parallel the applications from a number of users equal to or smaller than an upper limit number, and
the reception unit includes a unit that changes the upper limit number, based on contents of the applications from the number of users.

4. The application receiving system according to claim 3, wherein
the estimated reception start time and date information obtaining unit includes a unit that updates the estimated reception start time and date information, based on a change in the upper limit number.

5. The application receiving system according to claim 1, further comprising:
a unit that obtains, from the first user, content of the application from the first user before the reception of the application from the first user is started, wherein
the presentation unit includes a unit that presents information in accordance with the content of the application from the first user to the first user in a case where the start of the reception of the application is held on standby.

6. The application receiving system according to claim 1, wherein
the presentation unit includes a unit that presents information on a remaining quantity of the product or service to the first user in a case where the start of the reception of the application is held on standby.

7. The application receiving system according to claim 1, wherein
the presentation unit includes a unit that presents information on content of an application from the second user with an order earlier than the order of the first user to the first user in a case where the start of the reception of the application is held on standby.

8. The application receiving system according to claim 1, wherein
the presentation unit includes a unit that presents a waiting time until the estimated time and date at which the reception of the application is started to the first user at a predetermined time interval in a case where the start of the reception of the application is held on standby.

9. The application receiving system according to claim 1, further comprising
a unit that notifies the first user when the waiting time until the estimated time and date at which the reception of the application is started becomes equal to or smaller than a threshold.

10. The application receiving system according to claim 1, further comprising:
a determination unit that determines whether or not the first user is able to reserve or buy the product or the service, based on the order and a remaining quantity of the product or service, in a case where the start of the reception of the application is held on standby, and
a unit that notifies the first user of a result of determination by the determination unit.

11. A control method for an application receiving system, the control method comprising:
setting, in a case of access from a first user wanting to apply for reservation or purchase of a product or a service, an order for receiving an application from the first user;
holding start of reception of the application on standby, based on the order;
obtaining estimated reception start time and date information on an estimated time and date at which the reception of the application is started, based on the order, in a case where the start of the reception of the application is held on standby; and
presenting to the first user the estimated reception start time and date information obtained, wherein
the obtaining includes updating and obtaining the estimated reception start time and date information, based on a reception completion state concerning an application from a second user with an order earlier than the order of the first user, and
at the presenting, the estimated reception start time and date information updated and obtained is able to be presented to the first user.

12. A non-transitory computer readable information storage medium storing a program for causing a computer to:
set, in a case of access from a first user wanting to apply for reservation or purchase of a product or a service, an order for receiving an application from the first user;
hold start of reception of the application on standby, based on the order;
obtain estimated reception start time and date information on an estimated time and date at which the reception of the application is started, based on the order, in a case where the start of the reception of the application is held on standby; and
present to the first user the estimated reception start time and date information obtained, wherein
the program further causes the computer to update and obtain the estimated reception start time and date information, based on a reception completion state concerning an application from a second user with an order earlier than the order of the first user, and
the estimated reception start time and date information updated and obtained is able to be presented to the first user.
